(19) United States
(12) Patent Application Publication
(10) Pub. No.: US 2016/0317893 A1
(43) Pub. Date: Nov. 3, 2016

(54) Multi-Sport Exercise Device

(71) Applicant: Matthew John Kuntz, Helena, MT (US)

(72) Inventor: Matthew John Kuntz, Helena, MT (US)

(21) Appl. No.: 14/698,825

(22) Filed: Apr. 28, 2015

(51) Int. Cl. A63B 69/06; A63B 24/00; G09B 19/00

(52) U.S. Cl. CPC A63B 69/06; G09B 19/0038; A63B 24/0087; A63B 2069/068

(57) ABSTRACT

A multi-sport exercise machine that provides physical and visual stimulation to allows game players to use one piece of equipment to play a variety of games. The present invention has the ability to simulate multiple sports through the combination of angular movement and resistance with the principles of simulation and virtual reality to create an apparatus that is built to promote physical exercise and training in an unconventional way by allowing the user to play a variety of sporting games by standing, sitting, or lying prone while activating a variety of motion and resistance sensors. The present invention combines the principles of simulation and virtual reality through the use of a computer with monitor display or head mounted display to provide a machine that allows a user to play physically and virtually via video games many sports such as river boarding, surfing, kayaking, sledding or other similar sports.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates generally to equipment and devices used to exercise and train the human body. More particularly, this invention is related to an exercise machine that uses the principles of angular movement and resistance combined with the principles of simulation and virtual reality to provide an effective body workout as well as balance training for popular sports such as river boarding, body boarding, sledding, surfing, kayaking, skiing, and other similar activities.

2. Description of the Related Art

In recent years, there have been a number of devices that provide exercise and entertainment for their riders while simulating sports and other activities. Machines and devices that simulate motion such as the motion platform assembly for flight and vehicle simulation described in U.S. Pat. No. 6,027,342 to Brown and the motion simulator to Sarnicola in U.S. Pat. No. 5,366,375, are well known in the art. Other prior art using the simulation technique are focused on providing training to master a sport such as surfing described in the surf simulator platform and video game in US Pat. Appl. Pub. No. 2007/0155495 (Goo), the foot input type brain training device in US Pat. Appl. Pub. No. 2011/0014979 (Ueshima) and the balance perturbation system and trainer in US Pat. Appl. Pub. No. 2012/0071300 (Shapiro et al.). One of the key drawbacks to these machines is that they are designed solely to mimic a single sport or movement such as a rider standing and shifting their weight back and forth. As an example, the surfing simulator described in US Pat. Appl. Pub. No. 2007/70155495 (Goo) cannot be utilized in river boarding or body boarding games where the rider would put their chest on the wobbling board and activate sensors with their legs. 2 Similarly, there are number of machines and devices designed to simulate bicycle riding for use with bicycle simulation video games. The tilting bicycle simulator described U.S. Pat. No. 0,055,422 to Airmet et al. and the bicycle simulator described in U.S. Pat. No. 5,240,417 is well known in the art. However, there is no way to easily reconfigure those devices to simulate movements other than cycling. Specifically, the bicycling simulation devices could not also be utilized as a surfing simulator, body boarding simulator, kayaking simulator, or any other sporting movement simulation. The lack of adaptability in these devices minimizes their value to the consumer entertainment and exercise markets. The average consumer does not have the resources or space to purchase numerous sport simulation devices. However, the consumer's computer or video game console does have the ability to transition from games that simulate one sport to games that simulate another. There is a need for a multi-sport simulation device that allows game players to use one piece of equipment with attachments to play a variety of games. The present invention has the ability to simulate multiple sports through the combination of angular movement and resistance with the principles of simulation and virtual reality to create an apparatus that is built to promote physical exercise and training in an unconventional way by allowing the rider to play a variety of sporting games by standing, sitting, or lying prone while activating a variety of motion and resistance sensors. While certain sporting games may require the addition of an attachment for full enjoyment, the core of the apparatus and its microcontroller remain unchanged. The multi-sport exercise device of the present invention is built to be ergonomic, functional and aesthetically pleasing.

### BRIEF SUMMARY OF THE INVENTION

In one aspect, the present invention is a multi-sport simulation device that allows game players to use one piece of equipment with attachments to play a variety of games.

In another aspect, the present invention combines physical exercise with the principles of simulation and virtual reality through the use of a computer with monitor display or head mounted display (HMD) to provide a machine that allows a rider to stand, sit, while exercising their body and training for a sport such as river boarding, surfing, kayaking, sledding or other similar sport.

### DESCRIPTION OF THE DRAWINGS

For more complete understanding of the present invention, reference is now made to the following descriptions:

FIG. 1 is the rear left perspective view illustration of the present invention.

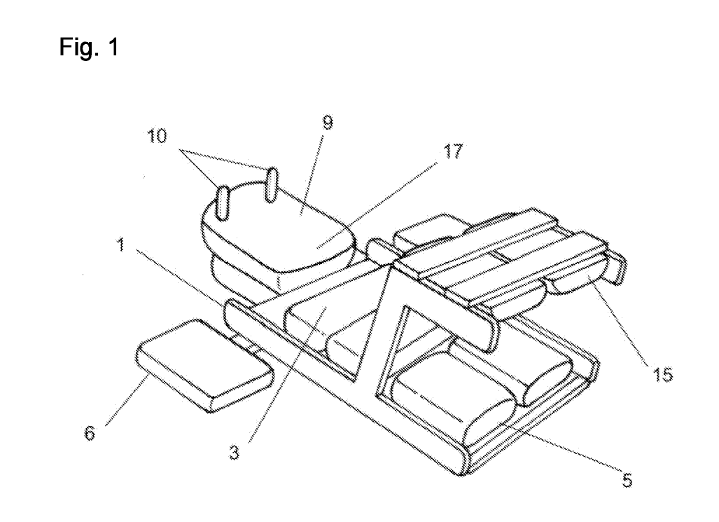

FIG. 2 is the left-side view illustration of the present invention where is the rider wear the head mounted display HMD and where is the monitor appear.

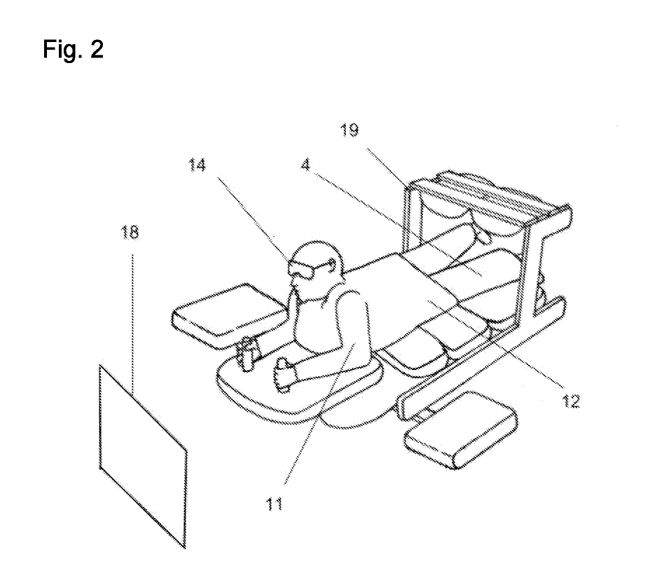

FIG. 3 is the perspective view illustration of the present invention depicting a rider practicing paddle boarding.

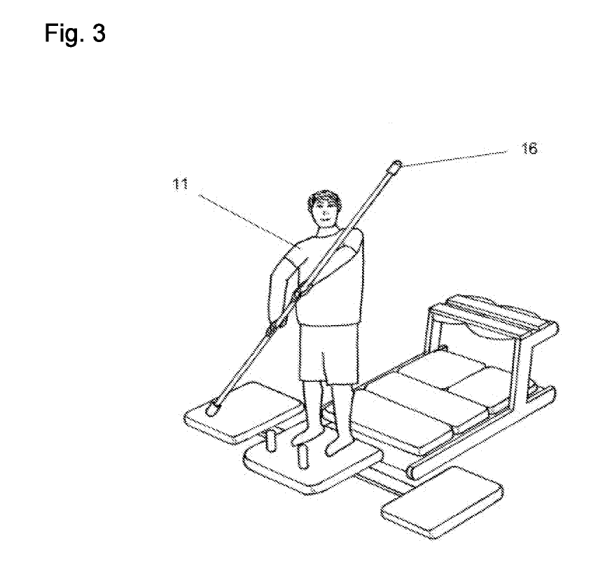

FIG. 4 is the left side illustration of the present invention.

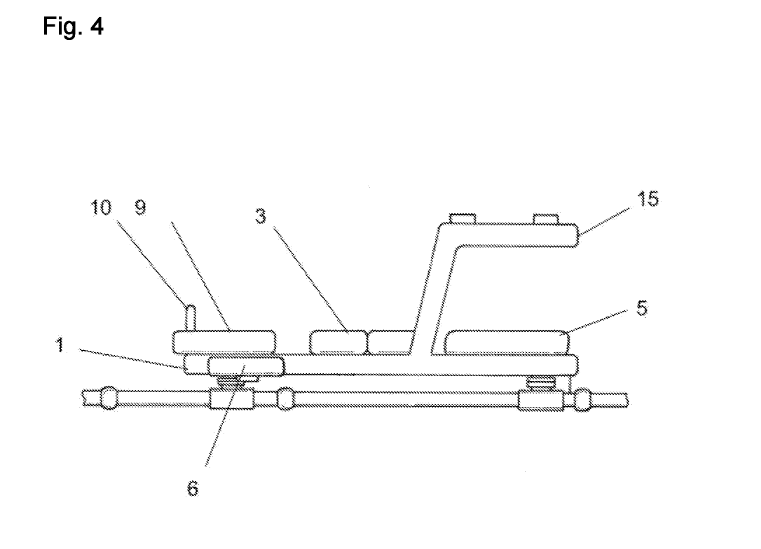

FIG. 5 is the left side illustration of the present invention where are the wobbling horizontal board, the upper portion of the frame and the river boarding attachment appear.

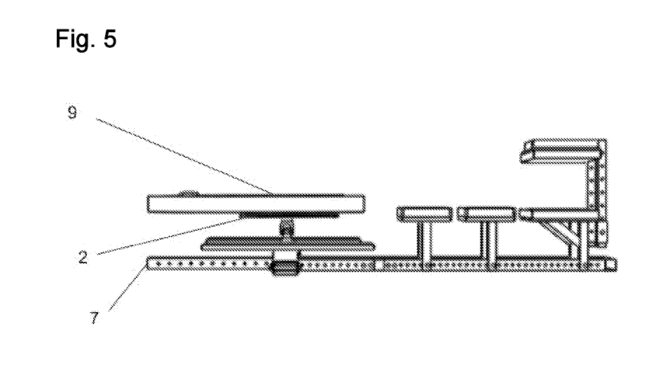

FIG. 6 is the front view illustration of the present invention.

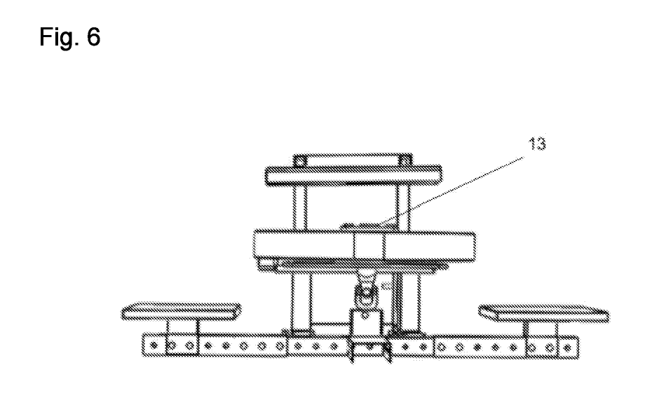

FIG. 7 is a perspective view illustration of the present invention where is the buttons appear.

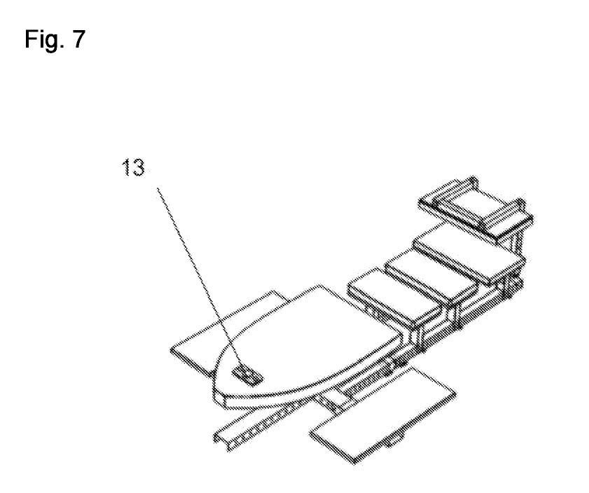

FIG. 8 is the left side illustration of the present invention where are the wobbling horizontal board and the accelerometer sensor appear.

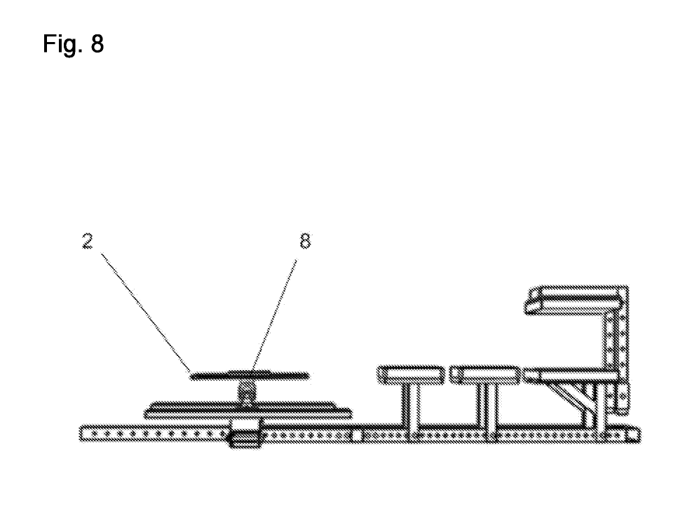

FIG. 9 is the top view illustration of the present invention where are the wobbling horizontal board and the accelerometer sensor appear.

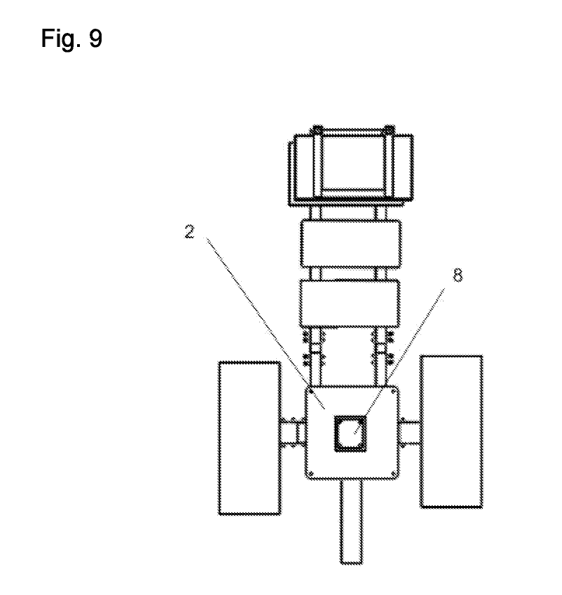

FIG. 10 is the perspective view of the present invention where are the wobbling horizontal board and the accelerometer sensor appear.

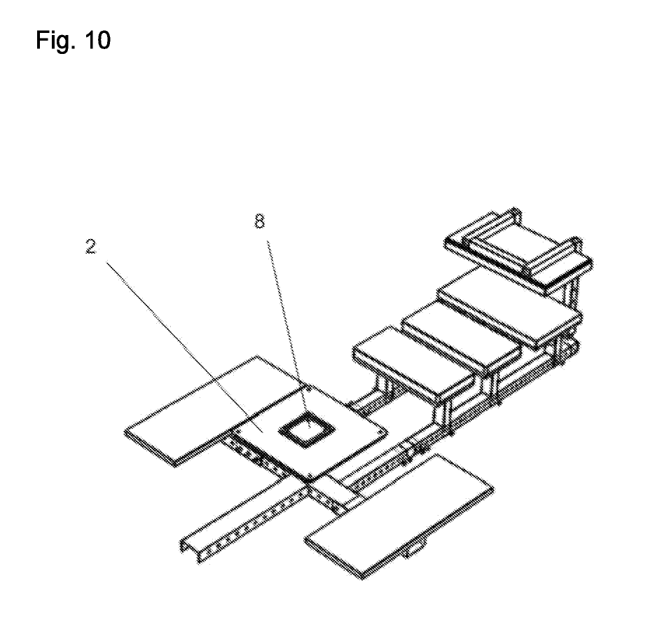

### REFERENCE NUMERALS IN THE DRAWINGS

For more complete understanding of the present invention, reference is now made to the following descriptions:
1—Frame.
2—A wobbling horizontal board.
3—Foam mats.
4—The rider's feet.
5—Lower leg resistance.
6—Peripheral pressure mat sensors.
7—The upper portion of the frame.
8—An accelerometer sensor.
9—A river boarding attachment.
10—Two handles.
11—The rider.
12—The rider's lower torso.
13—Buttons.
14—A head mounted display HMD.
15—The upper leg resistance.
16—A shaft.
17—The upper cradle section.
18—Monitor.
19—Parallel members.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention. All illustrations of the drawings are for the purpose of describing selected versions of the present invention and are not intended to limit the scope of the present invention.

The present invention overcomes a deficiency in the prior art for an exercise and training device that combines physical exercise with the principles of simulation and virtual reality through the use of a computer with monitor display or head mounted display (HMD) 14 to provide a machine that allows a rider 11 to stand, sit, or lay prone upon a wobbling horizontal board 2 while exercising their body and training for a sport such as river boarding, surfing, kayaking, sledding or other similar sport. In general, the multi-sport exercise machine of the present invention provides physical and visual stimulation to the user/rider of the device using the machine. In an exemplary embodiment of the present invention, the exercise device has a stationary, grounded outer frame 1 which houses a wobbling horizontal board 2, foam mats 3 to support the rider's body, the lower leg resistance 5 and the upper leg resistance 15 and peripheral pressure mat sensors 6, In this embodiment of the multisport exercise machine, the interior of the frame 1 is configured with a wobbling horizontal board 2 firmly attached horizontally to the upper portion of the frame 7 with a universal joint, ball joint or other assembly that allows the board to wobble forward, back, and to each side. An accelerometer sensor 8 is affixed to the face of the wobbling horizontal board 2. This accelerometer sensor 8 reports on the position and speed of the wobbling horizontal board 2 to the computer. In this embodiment, sport-specific attachments are affixed to the upper face of the wobbling horizontal board 2. In the exemplary embodiment of the multi-sport exercise device of the invention, a river boarding attachment 9 may be affixed to the upper face of the wobbling horizontal board 2, the river boarding attachment 9 has an upper cradle-shaped section with two handles 10 and a four lower flat section. In this embodiment, the rider 11 places their chest in the upper cradle section 17 and holds onto the two handles 10 attached to that section. In this prone position, the rider's lower torso 12 is placed on the flat section of the river boarding attachment 9. The river boarding attachment 9 is firmly affixed to the face of the wobbling horizontal board 2 so it moves with the wobbling horizontal board 2 when the rider rocks forward, backward and side to side.

In this embodiment of the invention, the two handles 10 on the river boarding attachment 9 may have buttons 13 that when pressed by the rider 11 allows the rider 11 to further interact with a computer game displayed either on a monitor 18 placed in front of the apparatus or on a head mounted display (HMD) 14.

In an exemplary embodiment of the multisport exercise device there are a leg resistant device affixed to the frame 1. The leg resistance device has two faces in parallel to each other, the lower leg resistance 5 and the upper leg resistance 15. The faces are supported by parallel members 19. the lower leg resistance 5 and the upper leg resistance 15 both have foam mats with pressure sensitive sensors to record the rider's leg movements when the rider 11 presses his foot or leg against the foam mats 3 in a kicking motion while trying to simulate river boarding, sledding or other sport movements.

In an exemplary embodiment of the multi-sport exercise device, the peripheral pressure mat sensors 6 are affixed to the frame 1 on both sides of the wobbling horizontal board 2. When using the device in the prone position, the rider 11 may engage the peripheral pressure mat sensors 6 with the rider's hands. When using the device in a standing position, the rider 11 may engage the peripheral pressure mat sensors 6 with the rider's feet 4 or with a shaft 16 held in the rider's hands. When using the device in a sitting or kneeling position, the rider 11 may engage the peripheral pressure mat sensors 6 either with the rider's hands or with a shaft 16 held in the rider's hands.

What I claim is:

1. An exercise and training simulator device comprising:
A new way to combines physical exercise with the principles of simulation and virtual reality through the use of a computer that allows game players to use one piece of equipment with attachments to play a variety of games the ability to simulate multiple sports through the combination of angular movement and resistance with the principles of simulation and virtual reality to create an apparatus that is built to promote physical exercise and training in an unconventional way by allowing the rider to play a variety of sporting games by standing, sitting, or lying prone while activating a variety of motion and resistance sensors;
the ability to simulate multiple sports through the combination of angular movement and resistance with the principles of simulation and virtual reality through the use of a computer with monitor display or head mounted display (HMD) to provide a machine that allows a rider to stand, sit, or lay prone upon a horizontal board while exercising their body and training for a sport such as river boarding, surfing, kayaking, sledding or other similar sport;

2. a stationary, grounded outer frame of the exercise and training device which houses a wobbling horizontal board, foam mats to support the lower body, leg resistance devices, and peripheral pressure mat sensors, the interior of the frame is configured with a wobbling board firmly attached horizontally to the upper portion of the frame with a universal joint, the frame rotates in three hundred and sixty degrees beneath the rider, the frame rotates both clockwise and counterclockwise, this rotation is dependent upon input from the computer game and pressure exerted by the chest of the rider on the wobbly board of the device.

3. a sport-specific attachments are affixed to the exercise and training device as defined in the claim 2 comprising:
a river boarding attachment may be affixed to the upper face of the wobbling board, the river boarding attachment has an upper cradle-shaped section with two handles and a lower flat section, the handles on the river board attachment may have buttons that when pressed by the rider allows the rider to further interact with a computer game displayed either on a monitor placed in front of the apparatus or on a HMD.
leg resistance attachments are affixed to the frame, the leg resistance device has two faces in parallel to each other, the lower leg resistance and the upper leg resistance these faces are supported by parallel members.
The bottom of the upper section and the top of the bottom section of the leg resistance device both have foam mats with pressure sensitive sensors to record the rider's leg movements when the rider presses their foot or leg against the foam mat in a kicking motion while trying to simulate river boarding, sledding or other sport movements.
a peripheral pressure mat sensors are affixed to the frame on both sides of the wobbling board. When using the device in the prone position, the rider may engage the peripheral pressure mat sensors with the rider's hands. When using the device in a standing position, the rider may engage the peripheral pressure mat sensors with the rider's feet or with a shaft held in the rider's hands. When using the device in a sitting or kneeling position, the rider may engage the peripheral pressure mat sensors either with the rider's hands or with a shaft held in the rider's hands.
